(19) United States
(12) Patent Application Publication
(10) Pub. No.: US 2017/0152063 A1
(43) Pub. Date: Jun. 1, 2017

(54) Internal air pressure imbalance (IAPI) engine

(71) Applicant: Steven Michael Blankman, Pensacola, FL (US)

(72) Inventor: Steven Michael Blankman, Pensacola, FL (US)

(21) Appl. No.: 14/998,532

(22) Filed: Nov. 28, 2015

(51) Int. Cl. B64G 1/40; F04D 17/16; B64G 1/44; F04D 29/44; F04D 29/46; F04D 17/10; F04D 27/00

(52) U.S. Cl. CPC B64G 1/409; F04D 17/10; F04D 17/16; F04D 27/002; F04D 29/441; F04D 29/462; B64G 1/446

(57) ABSTRACT

Disclosed is a thrust-producing device that can generate force in any medium (in air, in space, underwater). The device, in and of itself, does not have an external intake, or exhaust. Thrust is produced when electro-mechanical and/or thermal energy is applied to a closed, pressurized container of gas so as to produce an imbalance in the internal pressure within the container. A measure of corrosion prevention can be achieved by using N₂, an inert gas, or some other gas that will not chemically react with the other constituents in the container. Although this invention was principally intended as an advancement in the field of space propulsion systems, it has wide applicability across all modes of transportation; and has applications in stability and control, as well as propulsion.

### CROSS-REFERENCE TO RELATED APPLICATIONS

Not applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

The inventions pertains to propulsion systems for various modes of travel; Patent Classification 060, Power Plants.

All means of travel; whether on land, on the sea, beneath the sea, in the air, or in space; rely upon an engine of some sort for propulsive power. Most existing engines are air breathing, and are thus limited to terrestrial surface applications in the lower reaches of the atmosphere. Conventional air breathing engines do not work beneath the sea, or in the upper reaches of the atmosphere and beyond into space. Larger surface ships and submarines can run on nuclear powered power plants/steam; but at the current state of the art, the engine(s) simply drive a propeller(s) that is itself dependent upon the liquid medium to function. This arrangement, while suitable for ships and submarines, is too bulky for other terrestrial surface applications, and there is no present means of translating this type of nuclear power plant output into useful thrust for a spacecraft. Vessels powered by sail(s) can operate effectively; but are also constrained in speed and maneuverability by the wind and the medium in which they need to operate. Travel in outer space presents many unique challenges, as that medium offers very little to assist in the generation of thrust. Current spacecraft propulsion technologies rely heavily upon limited supplies of non-renewable materials (fuels, oxidizers, ion particles, etc.), the gravity of other celestial bodies, or solar sails. With all of these, there are serious constraints limiting our ability to freely travel through space. Speed and maneuverability are very much constrained by the limited magnitude and endurance of available discretionary propulsive power. Most spacecraft spend the bulk of their time in unpowered flight; drifting through space, or orbiting a celestial body. Their course/position is set, with little deviation possible. Simply launching an object into space, at the present state-of-the-art, is a huge, expensive undertaking; requiring large, specially built launch facilities (designed to deal with the heat, smoke, and noise), toxic fuels, and rockets/other resources that are for the most part nonrecoverable. If an object fails to reach the desired orbit; there is little that can be done to correct that. Once in orbit, or some other destination in space, most spacecraft are hopelessly stranded there. While some space vehicles can make a safe return to Earth; most satellites become useless space junk once their fuel supplies are depleted, or malfunctioning systems render them inoperable. Some are relegated to graveyard orbits, fall haphazardly back into the atmosphere, or simply remain in place indefinitely. The repair/refueling of a satellite is most uncommon. The safe retrieval of one is unheard of. The partial salvage of some satellite components is only very recently being contemplated. Propulsion is not the only problem we currently face with regard to space travel. Stability and Control systems are also largely constrained by the finite amount of fuel carried onboard. If we are going to conquer space; travel to other worlds (and back), mine asteroids, make more productive use of our satellites, protect ourselves from space debris and other near-Earth objects, etc.; we need a more robust capability to travel where we want, when we want!

### BRIEF SUMMARY OF THE INVENTION

This invention is based upon a new concept that compressed gas within a closed container can be acted upon in such a way as to create an imbalance in the distribution of pressure within the container. It is an engine capable of producing thrust from within a closed environment; and can therefore produce thrust independent of its operating medium. The engine requires an external power source that could come from nuclear power, renewable solar energy even cheaper and safer than nuclear power, or potentially other electrical or mechanical drive systems. Although this invention is primarily intended to address the aforementioned challenges with space travel, it has applications across all modes of travel, and in all operating mediums. Imagine for example; a boat that does not consume fossil fuels, pollute the atmosphere or water, and does not need to have rotating shafts or control mechanisms penetrating its hull! This engine provides for both new capabilities, and advancements to existing capabilities with regard to space operations; including space debris recovery, satellite refuel/repair/relocation/recovery, research/travel approaching the speed of light (and beyond), transportation to the moon or other planets, NEO/asteroid deflection, space tourism, etc. A spacecraft powered by this engine would not need expansive launch pads; or produce massive amounts of heat, smoke, or noise. And there are other possible uses for this invention in addition to propulsion. Attitude control for spacecraft or other terrestrial vehicles, and stability systems could also be based upon this concept.

### BRIEF DESCRIPTION OF THE SEVERAL VIEWS OF THE DRAWING

FIG. 1 depicts a simple, basic IAPA Engine using a centrifugal blower driven by a motor powered by an external electrical source.

FIG. 2 is a simplified illustration of a multi-stage engine concept with 1 centrifugal stage as in FIG. 1; augmented by 2 axial stages, a second inner centrifugal stage, and a rotating false boundary.

FIG. 3 is a simplified illustration showing a basic IAPA engine as in FIG. 1, augmented by the strategic addition and extraction of thermal energy.

FIG. 4 illustrates a potential use of the extreme temperature differentials encountered in space, and other extra-terrestrial environments, as a source of both heating and cooling.

FIG. 5 illustrates the possibility of a bipolar arrangement that provides the capability of pushing in either one direction, or another.

FIG. 6 illustrates yet another means of utilizing multiple mechanisms and the creation of thrust in different directions.

### DETAILED DESCRIPTION OF THE INVENTION

Disclosed is an invention that is based upon a new, unique concept that external energy can be applied to a closed, pressurized container of gas in such a way as to create an imbalance in the internal pressure within the container resulting in a net force suitable for use as a means of propulsion. There are a number of possibilities for making practical use of this concept. There are numerous methods for introducing external energy into the pressurized container which may be used either alone, or in combination with other methods. The internal container pressure, temperature, geometry (length, diameter, shape(s), etc.), number of stages, input power applied, and the mechanism(s) by which the external energy is introduced into the container are all options/variables that can be selected, or even manipulated, to achieve differing results as desired/required under different conditions. For instance; a typical aerospace application might prefer to focus more on thrust vs weight, whereas a seaborne application, not as concerned with weight, might instead choose to optimize thrust vs input power required. In any event, one of the main keys to making this concept work is to develop ways of acting on the compressed gas such that the equal and opposite reaction that will occur does not cancel out the desired result. Perhaps the best way to achieve this is for the applied external energy to perform work perpendicular to the desired direction of motion; but that is not absolutely necessary.

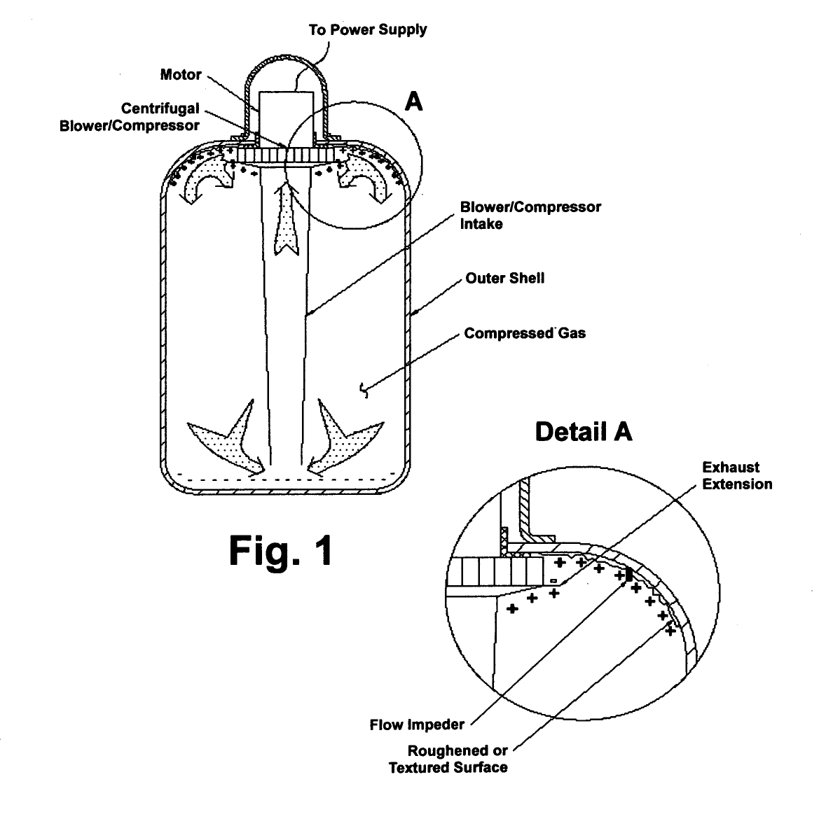

FIG. 1 illustrates a very simple yet practical application of this concept. Shown is a container filled with a compressed gas. A centrifugal blower/compressor is situated at the top of the container, with the axis of rotation aligned parallel with the desired direction of thrust. An inlet tube extends from the inlet of the blower down almost to the bottom of the container. At rest, the pressure is in equilibrium throughout the container. When the blower/compressor is energized; gas is drawn up from the bottom of the container through the intake, compressed, and expelled across the top of the container. From there, the air flows naturally back down the container, outside of the intake tube. The action of the blower upsets the resting equilibrium; creating lower pressures in the intake tube and at the bottom of the container, and higher pressures at the top of the container. In the figure; areas of increased pressure are indicated by plus signs (+), while areas of decreased pressure are signified by minus signs (−). The pressures along the sides of container are at all times countered by an equal and opposite pressure on the opposite side. However; the higher pressures now existing at the top of the container are not fully offset by the lower pressures at the bottom, thus creating a net force in the upward direction. As long as the blower is on, and the resulting internal air circulation continues; the device will produce this thrust. The effect can be amplified or optimized further through appropriate shaping of the container walls and/or placement of fairings/ducts to make maximum use of the aerodynamics involved. Although this is an entirely new and different concept; it is somewhat similar to the combustion chamber of an existing rocket engine. In an existing rocket engine; the pressure along the sides of the combustion chamber are equal and opposite; canceling each other out. But the pressure on the side opposite the opening has no counter-acting pressure, and is the source of thrust. In order to maintain this thrust; you need to supply a steady flow of a combustible mix of fuel and oxidizer. With this new IAPI engine; thrust is the result of pressure at one end of the “chamber” not fully countered by the pressure at the opposite end. And thrust is not maintained by a steady flow of fuel/oxidizer into the “chamber;” but by a steady flow of whatever energy is being used to establish/maintain the pressure imbalance.

Also depicted in this figure is an optional tapering of the intake tube. This capitalizes on the fact that pressures are higher on the outside of the tube than they are on the inside. If the tube is straight, the pressures are all balanced, and act perpendicular to the direction of desired motion. By designing the intake with some taper, there is now a component of the pressures that acts in parallel with the direction of desired motion; with the upward component stronger than the downward. Care must be taken in the design of a tapered intake. The size of the tube is constrained on the upper end by the size of the blower; and the opening at the bottom end must not be so small as to overly constrict the flow. This tapering is referred to as optional since other engine parameters such as length, number of stages (discussed later), etc.; may render this feature impractical. Other options exist for the geometry of the inlet tube. Partial flow restrictions, or a wavy or similar contouring, along the internal surface, could create additional reaction forces in the tube that contribute to the thrust generated. The idea is that the pressure on surfaces facing upward to the compressor/blower inlet will have lower pressures than those facing downward towards the incoming flow of air. But again, this must be balanced against the need to not overly restrict the flow. If the engine design is such that the intake tube rotates; this presents opportunities to even more significantly incorporate a tapered tube into the production of thrust. If the tube inner surface is smooth; the static pressure realized in the already relatively lower pressure intake tube will be even lower. And, if the exterior surface of the tube is not smooth; the pressure realized on the outer surface can be a total pressure, as opposed to simply a static pressure.

Another facet of how this invention can work deals with the relationships between velocity, dynamic pressure, static pressure, and total pressure; and how these relationships can be made to work for you, or at least made to not work against you. At rest, there is no velocity or dynamic pressure within the container; and static pressure is equal to the total pressure. In operation, the air is forced to flow throughout the container, and the total pressure now has both a static and dynamic component. The static pressure will therefore be relatively higher or lower in inverse proportion to the velocity of the flow. If the flow is permitted to flow smoothly across the top of the container; less than optimum results will be achieved. Adding obstacles, or even merely surface texture, to the top surface of the container (See FIG. 1) will serve to slow the flow, and therefore the static pressure realized across the top of the container will be higher. On the other hand, the optional extension added to the lowside of the blower outlet shown in FIG. 1 actually takes advantage of the relationship between static pressure and flow velocity. The gas exits the blower at relatively high velocity and flows across the top of this extension. This causes the static pressure pushing down on the shelf to be considerably lower than the static pressure pushing up on the bottom of this shelf; thus contributing to the net resultant force in the upward direction. The previously mentioned rotating tapered inlet tube is another example of using the relationship between static, dynamic, and total pressure. The concept could just as easily be applied to a simple, rotating flat plate. If the surface on one side of the plate is smooth, while the other side has some surface texture or obstructions; there will be a pressure differential across the plate.

The selection of the exact gas, or gaseous mix, to be used in the container does not have much of a direct influence on the resulting output. Compressed air is an obvious selection because it is cheap and readily available. However; the use of a less reactive gas, like N₂ or an inert gas, has advantages over more reactive gases like air, O₂, H₂, Cl₂, or F₂ in terms of mitigating the potentially life shortening degradation of the container and internal components.

There are also tradeoffs to be considered when selecting an operating, pressure for the gas inside the container. The higher the pressure, the higher the thrust that can be produced; but, depending upon the internal mechanisms, there will likely also be a corresponding increase in the input power required to drive that mechanism. But this is true in general, for any arrangement. The more thrust you want to get out of the device, the more power you will need to supply to the device.

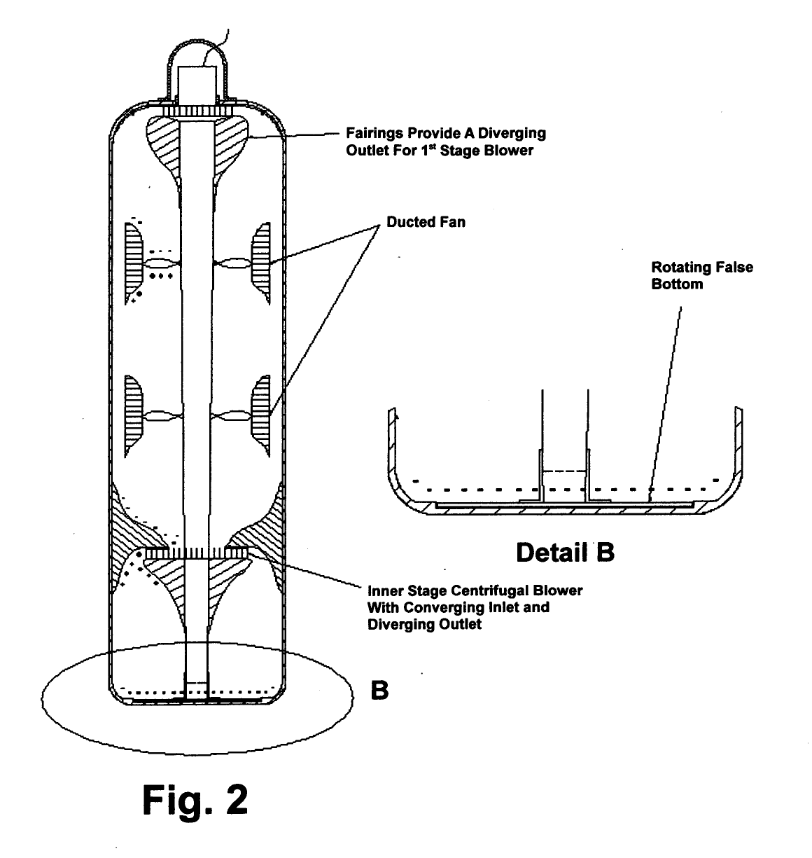

FIG. 2 is a simplified illustration of a multi-stage engine, and also shows another means of taking advantage of the relationship between static pressure and velocity. This engine includes a centrifugal blower at the top end with an intake duct extending down the center of the container as in FIG. 1. In this engine however; there are also two ducted axial fans and another centrifugal fan mounted in series. At the bottom end of the engine, is a rotating false bottom. There is room on the outside of each axial fan's ducting to allow return air to flow around the fan back to the intake. The ducts are shaped so as to create a converging nozzle for an intake, and a diverging nozzle for the exhaust. The inner stage centrifugal blower is mounted upside-down compared to the first stage blower. The inlet side is facing the top, pulling air in from above it; while ducting redirects the blower exhaust downward. Internal contouring, fairings, and ducting as needed create a converging inlet, and a diverging outlet to maximize the desired effect. As with the engine in FIG. 1; when the engine in FIG. 2 is at rest, the pressure within the container is distributed equally throughout the container. When the engine is energized; the centrifugal blower at the top, the rotating false bottom, the two ducted axial fans, and the inner stage centrifugal blower all rotate. The gas is drawn up the intake tube, creating lower pressure at the bottom; and blown out the top, increasing pressure along the upper inner container surface. The two ducted fans also work the gas in such a way as to generate thrust in the upward direction. The fan itself generating thrust; and the duct realizing a pressure differential between the higher pressures in the exhaust section of the duct vs the lower pressures in the inlet section. There is space between the duct and the container wall to provide an avenue for some fan exhaust gas to flow back around to the inlet. This is one of the ways of ensuring that an EQUAL and opposite reaction is not created within the container. Not shown; are optional holes in the inlet tube just below the ducted fans. These also help divert the down flow from the fans. At the inner stage centrifugal blower; there is suction drawing air and creating a low pressure area above the blower. The blower, oriented to blow outwards/downwards with the container shaped to direct the exhaust flow downward similar to how it is done at the top of the container, creates a high pressure area underneath of it. This furthers the development of thrust in the desired direction. Lastly; the rotating false bottom also contributes to creation of thrust in the upward direction by further decreasing the realized pressure felt on the bottom surface of the container. Also depicted in this figure are additional fairings at the first stage compressor/blower as a means of improving engine effectiveness.

In some situations; it might be desirable to have control mechanisms, to vary the amount of thrust produced, beyond the obvious means of varying the input power. The next most obvious method would be to incorporate variable geometry features to select internal components. The intake tube stands out as a good candidate. Some sort of aperture that provides a controllable choke point, or other design feature to vary the size of the tube inner diameter would provide a quick and fairly responsive method of varying the thrust produced by altering the efficiency of the engine. Other candidate components for the incorporation of variable geometry features include any ducting, the container walls, or the blower/compressor impeller. If a fan type blower/compressor is used, variable pitch fan blades would also be a viable option for controlling engine output.

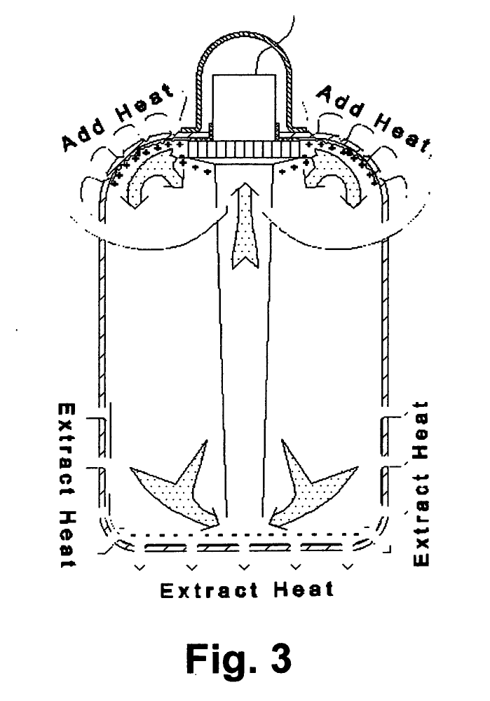

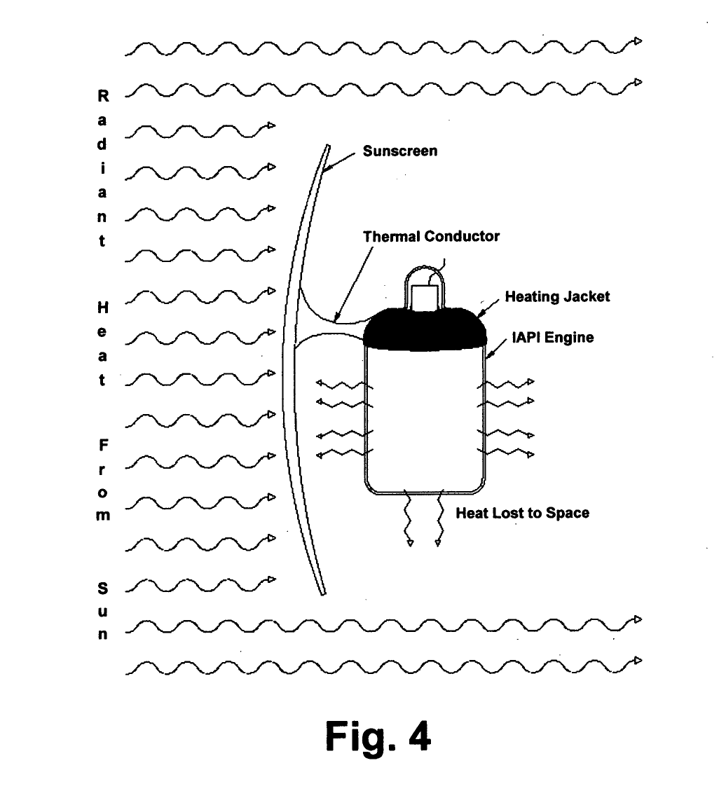

FIG. 3 is a simplified illustration of the strategic manipulation of temperature to further the desired ends. Heat is supplied to the flow in the inlet tube, blower, and the very top end of the container to further increase the pressure in the area where higher pressure is desired. Heat is then removed from the gas as it flows down the container back to the bottom, and at the container bottom; where lower pressure is desired. As a result of this supplemental heating/cooling; the thrust produced by the device will be higher than it otherwise would be. The source of the heat could be internal to the container (heat strips, the blower motor, heating elements could be used in the roughened/textured upper surface, etc.); or external (heating coils, a hot medium around the top of the container, etc.). It is a similar situation with removing heat; although internal options for cooling are very limited. But immersing the lower part of the container in a coolant, or surrounding it with cooling coils would be acceptable. Placing heat exchanger coils inside the container is not ideal as it would restrict flow, and generate pressure differentials across the heat exchangers counter to the desired direction of thrust. The temperature extremes encountered in extraterrestrial environments could also be the source of heating or cooling, potentially both. In space, and on many other celestial bodies, surfaces directly exposed to the Sun's rays can get very hot; yet it can be extremely cold in areas shielded from direct exposure to solar energy. A sunscreen could shield the engine from the extreme heat of the Sun. The engine would be in an extremely cold environment, constantly losing heat to its surroundings. But; the heat captured by the sunscreen could be carried through thermal conductors to provide the supplemental heating desired at specific locations within the engine. This is illustrated in FIG. 4. It is also possible that the outer hull of a spacecraft could serve as the means of collecting solar heat energy, in lieu of a separate sunscreen.

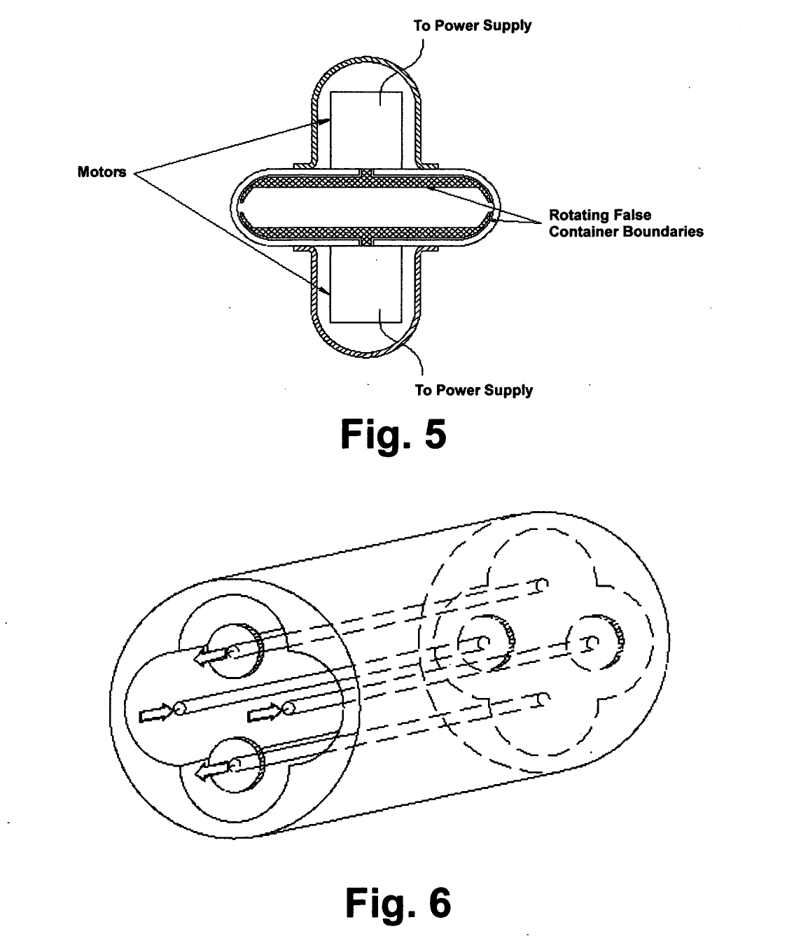

It is usually desirable for a vehicle to be able to move in more than merely one direction. Forward, and reverse, for example. With this type of engine, this can be accomplished by having more than one engine, or; by having a multi-polar engine capable of producing thrust in more than just the one direction. This is simply achieved by having more than one mechanism for creating the necessary pressure differential, with different orientations. FIGS. 5 and 6 are examples of bipolar arrangements of mechanisms within one container. You can produce thrust in either one direction, or the other, by supplying input energy only to the desired side. This type of arrangement is very suitable for stability and control applications (a ships rudder for example), as well as propulsion. For the sake of simplicity; only bipolar examples are illustrated. But there is no reason why an engine could not be produced with more than just two possible directions of thrust. Also, the simplified figures show a symmetry that is optional. The mechanisms for the different directions can be different in size/strength. For instance; in a car or boat, the reverse direction does not need to be as powerful as the forward direction. It could also be possible to have a mechanism that is movable; that can be reoriented in a different direction according to the direction in which the thrust is desired.

Also in the interest of simplicity; the views depict fans/blowers/compressors as simple centrifugal blowers or axial fans. But any sort of fan/blower/compressor that will sufficiently move the air and create the necessary pressure imbalance will work. It should be noted that the term blower/compressor, as commonly used in this disclosure, refers to any sort of device (such as a blower, compressor, fan, pump, vacuum, etc.) that operates by creating suction at one location, and expelling the gas at another. It should also be clear that this application does not purport to disclose any new or improved blower/compressor internal mechanisms. This invention simply identifies that such devices can be designed/shaped, and/or augmented with external shapes/ducting, and arranged in a container of compressed gas such that thrust can be produced. Obviously; the more powerful or efficient the compressor/blower, the potentially more powerful or efficient the engine will be. It should also be pointed out that centrifugal blowers/compressors introduce the external energy, and create opposing reactions, out of plane with the desired thrust; and therefore have advantages over axial type blowers/compressors in this application.

One problem that might be encountered with this type of engine is the creation of torque opposite the internal direction of rotation. There are a number of ways to deal with this torque. One way could be to have multiple mechanisms inside the container that turn in opposite directions. These mechanisms can be designed to create torques that cancel each other out. Another way is to have multiple engines with different internal directions of rotation to again, create torques equal and opposite each other. A third possibility would be to simply have a separate thrust producing device mounted on a sufficient moment arm to counter the torque created by the engine.

What I claim as my invention is:

1-6. (canceled)

7. A device capable of producing useful force, comprising: a closed container of gas; and a mechanism that acts upon the gas in such a way as to create an imbalance in the pressure distribution within the container yielding a net resultant force in a desired direction.

8. The device recited in claim 7 wherein the mechanism(s) for acting upon the gas within the container comprises a blower/compressor, moving false container internal surface(s), or other means of agitation; or any combination thereof.

9. The device recited in claim 8 further wherein variable speed motors drive the blower(s)/compressor(s) and/or moving internal surfaces as a means to control engine output.

10. The device for producing useful force recited in claim 8 wherein variable geometry blower/compressor inlets and/or outlets provide a means of controlling the magnitude of the net usable force produced.

11. The device for producing useful force recited in claim 8 wherein multiple mechanisms oriented in different directions may be employed such that usable forces can be selectively produced in different directions.

12. The device for producing useful force recited in claim 8 wherein the orientation of the internal mechanism can be changed as a means to change the direction of the net usable force.

13. The device for producing useful force recited in claim 7 further comprising optional flow control measures; so arranged to increase the effectiveness of the creation of the imbalance in the static pressure realized across the various surfaces internal to the container.

14. The device for producing useful force recited in claim 7 wherein heat is strategically added where, or in the circulation prior to where, high internal pressures are desired; and/or extracted where, or in the circulation prior to where, lower pressures are desired in order to augment the pressure differential created.

15. The device for producing useful force recited in claim 7 further comprising any compatible combination of blowers/compressors, moving internal boundary surfaces, or other sources of agitation with either a fixed or variable orientation; flow control measures; the means to manipulate temperature; variable geometry components; and multiple instances and/or multiple orientations thereof.

16. The device for producing useful force recited in claims 7, 8, 9, 10, 11, 12, 13, 14, and 15 wherein N₂, an inert gas, or other less reactive gas is used in lieu of air, or other relatively reactive gas as a means of preventing corrosion.
